(19) United States
(12) Patent Application Publication
(10) Pub. No.: US 2018/0003384 A1
(43) Pub. Date: Jan. 4, 2018

(54) COMBUSTOR INLET MIXING SYSTEM WITH SWIRLER VANES HAVING SLOTS

(71) Applicant: Siemens Aktiengesellschaft, München (DE)

(72) Inventor: Samer P. Wasif, Oviedo, FL (US)

(21) Appl. No.: 15/538,879

(22) PCT Filed: Jan. 22, 2015
(86) PCT No.: PCT/US2015/012358

§ 371 Date: Jun. 22, 2017

(51) Int. Cl. F23R 3/14; F01D 5/14; F23R 3/28; F23C 7/00; F01D 9/04

(52) U.S. Cl. CPC F23R 3/14; F23C 7/004; F01D 9/041; F01D 9/044; F23R 3/286; F23R 3/283; F01D 5/143; F05D 2240/80; F23C 2900/07001; F23R 2900/00005

(57) ABSTRACT

A combustor inlet mixing system (10) formed from a plurality of circumferentially spaced swirler vanes (38) extending radially outward from a nozzle hub. Each of the swirler vanes (38) may have a length (62) that extends downstream along at least a portion of the combustor inlet mixing system (10), and may further have a thickness (66) that extends along a circumference of the nozzle hub. At least one of the swirler vanes (38) may further have at least one slot (42) cut entirely through the thickness (66) of a portion of the swirler vane (38). The slot (42) may separate the swirler vane (38) from the nozzle hub along a portion of the length (62) of the swirler vane (38).

### FIELD OF THE INVENTION

This invention is directed generally to turbine engines, and more particularly to combustor air feed systems for turbine engines.

### BACKGROUND

Typically, gas turbine engines include a compressor for compressing air, a combustor for mixing the compressed air with fuel and igniting the mixture, and a turbine blade assembly for producing power. Compressed air is fed to a plurality of combustors via plenums. Combustors often operate at high temperatures that may exceed 2,500 degrees Fahrenheit. This high temperature creates great thermal stress within the combustor and adjacent components and may overheat adjacent components, such as the heat shield protecting the pilot nozzle hub. Furthermore, typical efforts to prevent overheating to the heat shield may be deficient.

### SUMMARY OF THE INVENTION

This invention relates to a combustor inlet mixing system formed from a plurality of circumferentially spaced swirler vanes extending radially outward from a nozzle hub. At least one of the swirler vanes may have at least one slot cut entirely through the thickness of a portion of the swirler vane, and which may separate the swirler vane from the nozzle hub along a portion of the length of the swirler vane. The slot may be configured to add a layer of at least partially non-swirling air around the nozzle hub. In particular embodiments, this may prevent overheating to the heat shield protecting the nozzle hub. Furthermore, this may result in further optimization of cooling air for the nozzle hub, resulting in lower emissions and/or allowing for the heat shield to be removed from the nozzle hub, in particular embodiments.

According to one embodiment, a turbine engine may include at least one combustor positioned upstream from a rotor assembly. The rotor assembly may include at least one row of turbine blades extending radially outward from a rotor. A compressor may be positioned upstream from the combustor. At least one compressor exhaust plenum may extend between the compressor and the combustor. At least one combustor inlet mixing system may be formed from a plurality of circumferentially spaced swirler vanes extending radially outward from a nozzle hub. Each of the swirler vanes may have a length that extends downstream along at least a portion of the combustor inlet mixing system, and may further have a thickness that extends along a circumference of the nozzle hub. At least one of the swirler vanes (or each of the swirler vanes, or at least half of the swirler vanes, or at least one third of the swirler vanes, or at least one fourth of the swirler vanes) may further have at least one slot cut entirely through the thickness of a portion of the swirler vane. The slot may separate the swirler vane from the nozzle hub along a portion of the length of the swirler vane (or along at least one fourth of the length of the swirler vane, or along at least one half of the length of the swirler vane, or along at least two thirds of the length of the swirler vane, or along at least three fourths of the length of the swirler vane). The slot may be configured to add a layer of non-swirling air (or at least partially non-swirling air) around the nozzle hub.

The nozzle hub may be a pilot nozzle hub. Furthermore, the nozzle hub may be a main nozzle hub and the swirler vanes may be main swirler vanes. The nozzle hub may include a heat shield positioned downstream of the swirler vanes. Additionally, the nozzle hub may include a gas diffusion outlet positioned downstream of the swirler vanes. Each of the plurality of swirler vanes may have a curved contour or a twisted contour, or both. Furthermore, the swirler vanes may be manufactured (e.g., cast, rapid prototype, stereolithography, etc.) with the at least one slot, or the swirler vanes may be modified to include the at least one slot.

In another embodiment, a turbine engine may include at least one combustor positioned upstream from a rotor assembly. The rotor assembly may include at least one row of turbine blades extending radially outward from a rotor. A compressor may be positioned upstream from the combustor. At least one compressor exhaust plenum may extend between the compressor and the combustor. At least one combustor inlet mixing system may be formed from a plurality of circumferentially spaced swirler vanes extending radially outward from a pilot nozzle hub. Each of the swirler vanes may have a length that extends downstream along at least a portion of the combustor inlet mixing system, and may further have a thickness that extends along a circumference of the pilot nozzle hub. Each of at least half of the swirler vanes may have at least one slot cut entirely through the thickness of a portion of the swirler vane. The slot may separate the swirler vane from the pilot nozzle hub along at least one half of the length of the swirler vane. The slot may be configured to add a layer of at least partially non-swirling air around the pilot nozzle hub. The pilot nozzle hub may include a heat shield positioned downstream of the swirler vanes. Furthermore, each of the swirler vanes may have a curved contour.

In another embodiment, a turbine engine may include at least one combustor positioned upstream from a rotor assembly. The rotor assembly may include at least one row of turbine blades extending radially outward from a rotor. A compressor may be positioned upstream from the combustor. At least one compressor exhaust plenum may extend between the compressor and the combustor. At least one combustor inlet mixing system may be formed from a plurality of circumferentially spaced swirler vanes extending radially outward from a pilot nozzle hub. Each of the swirler vanes may have a length that extends downstream along at least a portion of the combustor inlet mixing system, and may further have a thickness that extends along a circumference of the pilot nozzle hub. Each of the swirler vanes may have at least one slot (or only one slot) cut entirely through the thickness of a portion of the swirler vane. The slot may separate the swirler vane from the pilot nozzle hub along at least two thirds of the length of the swirler vane. The slot may be configured to add a layer of at least partially non-swirling air around the pilot nozzle hub. The pilot nozzle hub may include a heat shield positioned downstream of the swirler vanes, and may also include a diffusion gas outlet positioned downstream of the swirler vanes. Furthermore, each of the swirler vanes may have a curved contour.

An advantage of the combustor inlet mixing system is that the system may create a layer of non-swirling air that may act as a coolant for the pilot nozzle hub, may prevent the recirculation zone from getting too close to the pilot nozzle hub or may change the structure or the recirculation zone, due to lack of swirl, by eliminating hub rich recirculation, or both. In particular embodiments, this may prevent overheating to the heat shield.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional side view of a portion of a turbine engine including a compressor, a combustor, a rotor assembly, and a compressor inlet flow mixing system.

FIG. 2 is a cross-sectional side view of a combustor inlet of an annular combustor with the combustor inlet mixing system.

FIG. 3 is a perspective view of the swirler vanes of the combustor inlet mixing system of FIG. 2.

### DETAILED DESCRIPTION OF THE INVENTION

A combustor inlet mixing system 10 formed from a plurality of circumferentially spaced swirler vanes 38 extending radially outward from a nozzle hub (such as a pilot nozzle hub 34 or a main nozzle hub) is disclosed. At least one of the swirler vanes 38 may have at least one slot 42 cut entirely through the thickness 66 of a portion of the swirler vane 38, and which may separate the swirler vane 38 from the nozzle hub along a portion of the length 62 of the swirler vane 38. As such, the combustor inlet mixing system 10 may create a layer of non-swirling air that may act as a coolant for the nozzle hub, may prevent the recirculation zone 60 from getting too close to the nozzle hub, and/or may change the structure or the recirculation zone 60, due to lack of swirl, by eliminating hub rich recirculation.

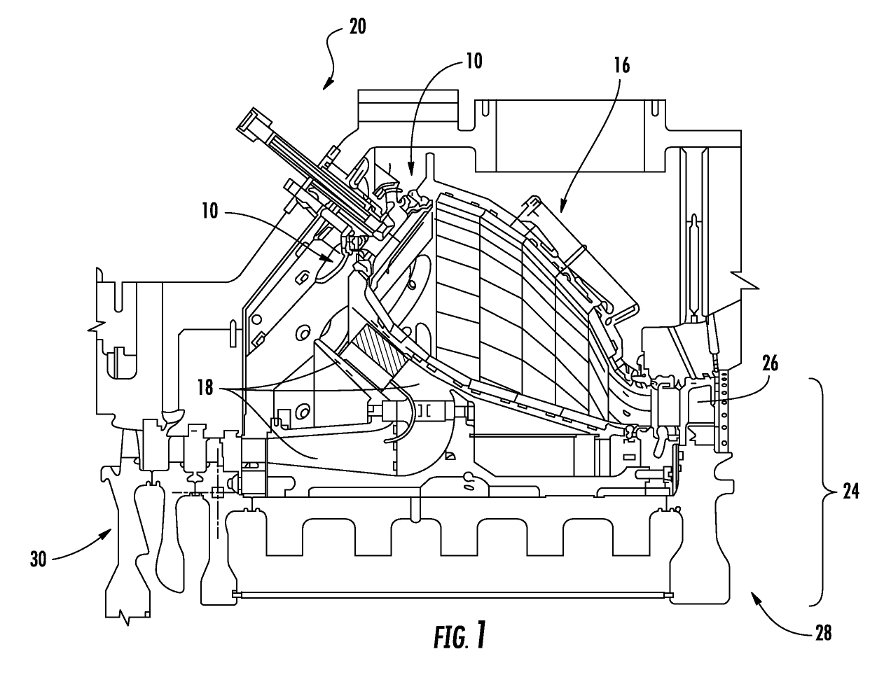

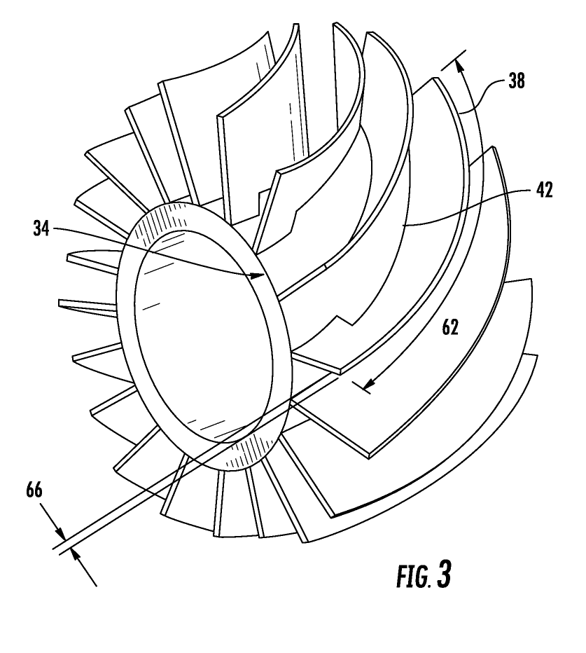

As shown in FIGS. 1-3, the turbine engine 20 may include one combustor 16 positioned upstream from the rotor assembly 24. The rotor assembly 24 may include one or more rows of turbine blades 26 extending radially outward from the rotor 28. The compressor 30 may be positioned upstream from the combustor 16. One or more compressor exhaust plenums 18 may extend between the compressor 30 and the combustor 16. A combustor inlet mixing system 10 may be formed from a plurality of circumferentially spaced swirler vanes 38 extending radially outward from a pilot nozzle hub 34. As shown in FIG. 3, each of the swirler vanes 38 may have a length 62 that extends downstream along at least a portion of the combustor inlet mixing system 10, and may further have a thickness 66 that extends along a circumference of the pilot nozzle hub 34. At least one of the swirler vanes 38 may further have at least one slot 42 cut entirely through the thickness 66 of a portion of the swirler vane 38. The slot 42 may separate the swirler vane 38 from the pilot nozzle hub 34 along a portion of the length 62 of the swirler vane 38.

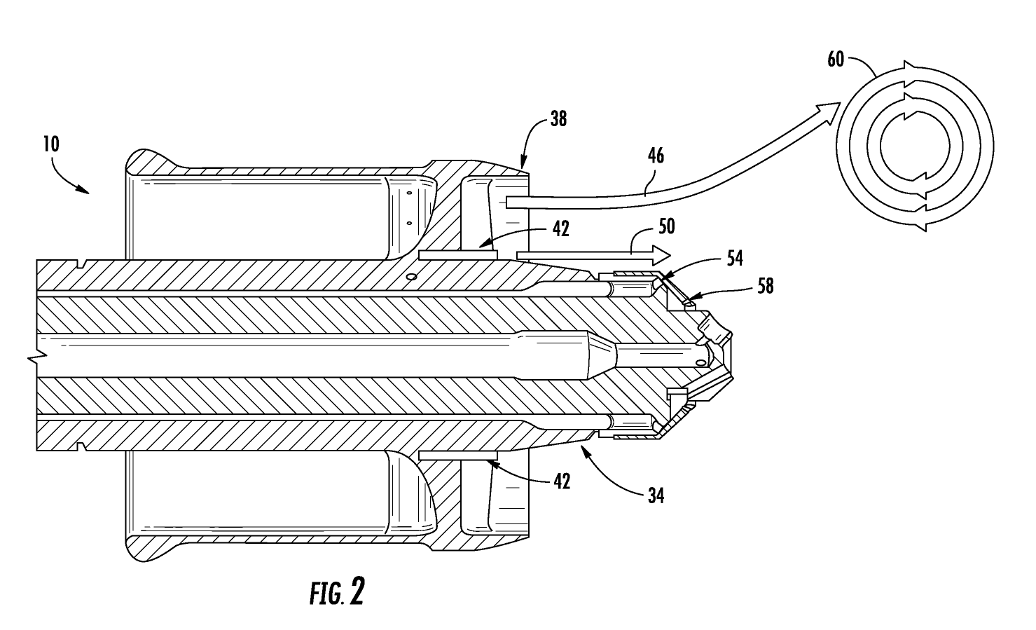

As shown in FIG. 2, an inner portion of the combustor inlet mixing system 10 may be formed from the pilot nozzle hub 34, and the outer portion of the combustor inlet mixing system 10 may be formed from the swirler vanes 38 extending radially outward from the pilot nozzle hub 34. The pilot nozzle hub 34 may include a heat shield 58 positioned downstream from the swirler vanes 38 and configured to protect the pilot nozzle hub 34 from the heat from the combustor 16. Additionally, in particular embodiments, the pilot nozzle hub 34 may further include a gas diffusion outlet 54 positioned downstream from the swirler vanes 38.

As further shown in FIG. 2, one or more slots 42 may be cut into one or more swirler vanes 38. The slot 42 may be configured to add a layer of non-swirling air 50 (or at least partially non-swirling air 50) around the pilot nozzle hub 34. That is, contrary to the swirling air 46 created by the outer portions of the swirler vanes 38, the slot 42 may be configured to allow air to pass through the swirler vane 38 without being swirled, rotated, or mixed (or with only a negligible amount of swirling, rotation, or mixing). This may, in particular embodiments, allow the non-swirling air 50 to act as a coolant for the pilot nozzle hub 34 or for the heat shield 58 protecting the pilot nozzle hub 34, or both, may prevent the recirculation zone 60 from getting too close to the pilot nozzle hub 34 or the heat shield 58, or both, or may change the structure of the recirculation zone 60, or both, due to lack of swirl, by eliminating hub rich recirculation. As such, overheating to the pilot nozzle hub 34 or to the heat shield 58, or both, from excessive temperatures may be prevented. Furthermore, this may result in further optimization of cooling air for the pilot nozzle hub 34, resulting in lower emissions and/or allowing for the heat shield 58 to be removed from the pilot nozzle hub 34, in particular embodiments.

As illustrated in FIG. 3, the outer portion of the combustor inlet mixing system 10 may be formed from a plurality of swirler vanes 38 extending radially outward from the pilot nozzle hub 34. The combustor inlet mixing system 10 may include any suitable number of swirler vanes 38, such as four swirler vanes 38, eight swirler vanes 38, twelve swirler vanes 38, or any other number of swirler vanes 38. Each of the swirler vanes 38 may have a length 62 that extends downstream along at least a portion of the combustor inlet mixing system 10. The length 62 of each of the swirler vanes 38 may be the same, or the length 62 of one or more of the swirler vanes 38 may be different. Furthermore, each of the swirler vanes 38 may have a thickness 66 that extends along a circumference of the pilot nozzle hub 38. The thickness 66 of each of the swirler vanes 38 may be the same, or the thickness 66 of one or more of the swirler vanes 38 may be different. Additionally, the thickness 66 of a swirler vane 38 may vary along the length or width of the swirler vane 38, or both. The swirler vanes 38 may have any suitable shape for mixing air and gas. For example, the swirler vanes 38 may have a curved contour, a twisted contour, any other shape, or any combination of the preceding. Additionally, all of the swirler vanes 38 may have the same shape, or one or more of the swirler vanes 38 may have different shapes.

One or more slots 42 may be cut into one or more of the swirler vanes 38. Any number of slots 42 may be cut into a swirler vane 38. For example, one slot 42 may be cut into a swirler vane 38, two slots 42 may be cut into a swirler vane 38, three slots 42 may be cut into a swirler vane 38, or any other number of slots 42 may be cut into a swirler vane 38. Furthermore, one or more slots 42 may be cut into any number of the swirler vanes 38. For example, one or more slots 42 may be cut into one swirler vane 38, two swirler vanes 38, three swirler vanes 38, at least one fourth of the swirler vanes 38, at least one third of the swirler vanes 38, at least one half of the swirler vanes 38, at least two thirds of the swirler vanes 38, at least three fourths of the swirler vanes 38, all of the swirler vanes 38, or any other number of the swirler vanes 38.

According to the illustrated embodiment, a slot 42 may be cut into the swirler vane 38 adjacent to the pilot nozzle hub 34, thereby separating the swirler vane 38 from the pilot nozzle hub 34 along a portion of the length 62 of the swirler vane 38. In another embodiment, the slot 42 may be cut into the swirler vane 38 at any other position on the swirler vane 38. For example, the slot 42 may be cut into the swirler vane 38 at any other position on the swirler vane 38 that may allow the slot 42 to add a layer of non-swirling air 50 around (or near) the pilot nozzle hub 34. As further illustrated in FIG. 3, the slot 42 may be cut entirely through the thickness 42 of a portion of the swirler vane 38. As such, the slot 42 may be configured to allow air to pass through the swirler vane 38 without being swirled, rotated, or mixed (or with only a negligible amount of swirling, rotation, or mixing). The slot 42 may have any suitable size and/or shape. For example, the slot 42 may be sized to separate the swirler vane 38 from the pilot nozzle hub 34 along at least one fourth of the length 62 of the swirler vane 38, along at least one third of the length 62 of the swirler vane 38, along at least one half of the length 62 of the swirler vane 38, along at least two thirds of the length 62 of the swirler vane 38, along at least three fourths of the length 62 of the swirler vane 38, or any other portion of the length 62 of the swirler vane 38. As another example, the slot 42 may be square, rectangular, oval, circular, any other suitable shape, or any combination of the preceding. Furthermore, the slot 42 may be vane cut back (as is illustrated in FIGS. 2 and 3) on the swirler vane 38 or vane cut forward on the swirler vane 38. Additionally, each swirler vane 38 may have the same sized, shaped, and/or positioned slot 42, or one or more of the swirler vanes 38 may have a different sized, shaped, and/or positioned slot 42.

The swirler vane 38 may be cast (or otherwise formed) with the slot 42. As such, the swirler vane 38 may be manufactured with the slot 42 already cut into the swirler vane 38. In another embodiment, the swirler vane 38 may be modified to include the slot 42. For example, after the swirler vane 38 is already manufactured (or even after it has already been used in a gas turbine engine), the slot 42 may be machined into the swirler vane 38 (or the swirler vane 38 may be otherwise modified to include the slot 42).

During use, compressed air flows into the combustor inlet mixing system 10 formed from a plurality of circumferentially spaced swirler vanes 38 extending radially outward from a pilot nozzle hub 34. A portion of the compressed air may be swirled, rotated, or mixed by the swirler vanes 38, creating a layer of swirling air 46 that may include a mixture of air and gas. Another portion of the compressed air may pass through one or more slots 42 cut into one or more of the swirler vanes 38 without being swirled, rotated, or mixed, or with only a negligible amount of swirling, rotation, or mixing. This may add a layer of non-swirling air 50, or at least partially non-swirling air 50, along the pilot nozzle 34 to act as a coolant for the pilot nozzle hub 34 or for the heat shield 58 protecting the pilot nozzle hub 34, or both, may prevent the recirculation zone 60 from getting too close to the pilot nozzle hub 34 or the heat shield 58, or both and/or may change the structure or the recirculation zone 60, due to lack of swirl, by eliminating hub rich recirculation. As such, overheating to the pilot nozzle hub 34 or to the heat shield 58, or both, from excessive temperatures may be prevented.

Although the invention has been discussed above with regard to a pilot nozzle hub 34, in particular embodiments, the invention may be utilized with one or more main nozzle hubs. For example, with regard to a main nozzle hub, at least one of the main swirler vanes 38 may have at least one slot 42 cut entirely through the thickness 66 of a portion of the main swirler vane 38, and which may separate the main swirler vane 38 from the main nozzle hub along a portion of the length 62 of the main swirler vane 38, as is discussed in detail above. In particular embodiments, this may change the flame structure of the main nozzle hub, and may result in optimized acoustic behavior (or improved flashback resistance) that could lead to lower emissions.

The foregoing is provided for purposes of illustrating, explaining, and describing embodiments of this invention. Modifications and adaptations to these embodiments will be apparent to those skilled in the art and may be made without departing from the scope or spirit of this invention.

It is claimed:

1-17. (canceled)

18. A turbine engine, comprising:
at least one combustor positioned upstream from a rotor assembly, wherein the rotor assembly includes at least one row of turbine blades extending radially outward from a rotor;
a compressor positioned upstream from the at least one combustor;
at least one compressor exhaust plenum extending between the compressor and the at least one combustor; and
at least one combustor inlet mixing system formed from a plurality of circumferentially spaced swirler vanes extending radially outward from a nozzle hub, each of the plurality of swirler vanes having a length that extends downstream along at least a portion of the at least one combustor inlet mixing system and further having a thickness that extends along a circumference of the nozzle hub, wherein at least one swirler vane of the plurality of swirler vanes further has at least one slot cut entirely through the thickness of a portion of the at least one swirler vane, the at least one slot separating the at least one swirler vane from the nozzle hub along a portion of the length of the at least one swirler vane.

19. The turbine engine of claim 18, wherein the at least one slot is configured to add a layer of at least partially non-swirling air around the nozzle hub.

20. The turbine engine of claim 18, wherein the at least one slot is configured to add a layer of non-swirling air around the nozzle hub.

21. The turbine engine of claim 18, wherein the nozzle hub comprises a heat shield positioned downstream of the plurality of swirler vanes.

22. The turbine engine of claim 18, wherein the nozzle hub comprises a gas diffusion outlet positioned downstream of the plurality of swirler vanes.

23. The turbine engine of claim 18, wherein each of the plurality of swirler vanes has at least one slot cut entirely through the thickness of a portion of the each of the plurality of swirler vanes, the at least one slot of the each of the plurality of swirler vanes separating the each of the plurality of swirler vanes from the nozzle hub along a portion of the length of the each of the plurality of swirler vanes.

24. The turbine engine of claim 18, wherein each of at least half of the plurality of swirler vanes has at least one slot cut entirely through the thickness of a portion of the each of at least half of the plurality of swirler vanes, the at least one slot of the each of at least half of the plurality of swirler vanes separating the each of at least half of the plurality of swirler vanes from the nozzle hub along a portion of the length of the each of at least half of the plurality of swirler vanes.

25. The turbine engine of claim 18, wherein each of at least one fourth of the plurality of swirler vanes has at least one slot cut entirely through the thickness of a portion of the each of at least one fourth of the plurality of swirler vanes, the at least one slot of the each of at least one fourth of the plurality of swirler vanes separating the each of at least one fourth of the plurality of swirler vanes from the nozzle hub along a portion of the length of the each of at least one fourth of the plurality of swirler vanes.

26. The turbine engine of claim 18, wherein each of at least one third of the plurality of swirler vanes has at least one slot cut entirely through the thickness of a portion of the each of at least one third of the plurality of swirler vanes, the at least one slot of the each of at least one third of the plurality of swirler vanes separating the each of at least one third of the plurality of swirler vanes from the nozzle hub along a portion of the length of the each of at least one third of the plurality of swirler vanes.

27. The turbine engine of claim 18, wherein each of the plurality of swirler vanes has a curved contour.

28. The turbine engine of claim 18, wherein each of the plurality of swirler vanes has a twisted contour.

29. The turbine engine of claim 18, wherein the at least one slot separates the at least one swirler vane from the nozzle hub along at least one half of the length of the at least one swirler vane.

30. The turbine engine of claim 18, wherein the at least one slot separates the at least one swirler vane from the nozzle hub along at least one fourth of the length of the at least one swirler vane.

31. The turbine engine of claim 18, wherein the at least one swirler vane is manufactured with the at least one slot.

32. The turbine engine of claim 18, wherein the at least one swirler vane is modified to include the at least one slot.

33. The turbine engine of claim 18, wherein the nozzle hub comprises a pilot nozzle hub.

34. The turbine engine of claim 18, wherein the nozzle hub comprises a main nozzle hub and the plurality of swirler vanes comprise a plurality of main swirler vanes.
